(19) United States
(12) Patent Application Publication
(10) Pub. No.: US 2023/0335096 A1
(43) Pub. Date: Oct. 19, 2023

(54) Systems and Methods Related to Stringed Instrumental Sound Pickup, Mixing, and/or Distribution

(71) Applicant: Seth A. Spartan, Oconomowoc, WI (US)

(72) Inventor: Seth A. Spartan, Oconomowoc, WI (US)

(21) Appl. No.: 17/721,923

(22) Filed: Apr. 15, 2022

(51) Int. Cl. G10H 3/18

(52) U.S. Cl. CPC G10H 3/181; G10H 3/186

(57) ABSTRACT

Systems and methods for pickup, mixing, and/or distribution of sound include use of a humbucker positioned within a sound hole of a stringed instrument. Generally, the humbucker is supported by a sound hole adaptor that, alone or in combination with the humbucker, preferably obscures a majority of the sound hole, but does not obscure the entirety of the sound hole. Such arrangement ultimately may enable broadcast of a first sound, acoustically from the sound hole, and a second sound, transduced from the humbucker.

### BACKGROUND OF THE INVENTION

Stringed instruments have long entertained the human ear. Stringed instruments range in complexity from a single-string or monochord zither (e.g., an Ethiopian ektara) to more complex multi-string bowed instruments (e.g., violins, violas, cellos) and string manipulated instruments (e.g., banjos, guitars, ukuleles), and even keyed strings, such as a piano. While over the years many of these devices have been electrified, there is still popularity of non-electric, or acoustic instruments, or a combination of electric and acoustic properties and/or abilities.

One popular electrified acoustic stringed instrument is an acoustic electric guitar. While the basic structure of an acoustic guitar is known, an acoustic guitar sound is generated by strings of various materials, of various thicknesses, and/or of various tensions being plucked or strummed. The plucking or strumming causes the string(s) to vibrate over a sound hole formed through a front face of a hollow body. The vibrating string(s) cause vibrations of the soundboard (through the saddle) of the guitar body, which causes pressure differentials within the guitar body, which result in sound waves (e.g., compression waves) to exit the sound hole and to be perceived by the human ear.

Rather than relying solely on compression waves generated by a purely acoustic guitar, an acoustic electric guitar includes one or more pickup devices to convert or transduce physical vibrations into an electrical signal. Pickup devices in/on an otherwise acoustic guitar can vary by placement and/or by technology. Regarding placement, pickups may be placed inside the guitar body and in physical contact with the soundboard (i.e., the front face of the guitar) on an opposite side of the soundboard from the saddle, otherwise inside the guitar body in physical contact with the soundboard, otherwise supported by the guitar body (e.g., a microphone) either positioned inside or outside of the body, or supported within the sound hole.

Contact pickups usually employ a piezoelectric device, which transduces vibrations to an electrical signal that is then conveyed to a mixer and/or amplifier for broadcast to one or more listeners, or for further electronic processing. Contactless pickups generally include microphones (which also may use a piezoelectric material to transduce soundwaves to an electrical signal) or magnetic pickups, which sense magnetic field variations and transduce such variations to an electrical signal that is then conveyed to a mixer and/or amplifier for broadcast to one or more listeners, or for further electronic processing.

Contactless pickups can be of various types, including single coil, or double coil (e.g., humbucker). As its nom de plume may suggest, a double coil pickup bucks (or reduces) humming (e.g., alternating magnetic fields caused by AC power supply mains) that may otherwise distort generated sound quality. Conventional sound engineering informs that humbuckers are generally not well-suited for use in acoustic environs, but rather are primarily adapted for use in high-distortion genres such as heavy metal, punk, grunge, or other genre using a driving electric guitar. Meanwhile, prior acoustic electric guitars have primarily used single coil pickups, which may have been supported by such guitar to provide a single electrical output for further amplification and/or processing.

Accordingly, the art of sound pickup, mixing, and/or distribution of stringed instruments would benefit from improved systems and methods to provide one or more advantages over prior devices.

### SUMMARY OF THE INVENTION

The present invention provides systems and methods for improved sound pickup, mixing, and/or distribution related to otherwise acoustic or acoustic electric stringed instruments.

According to an aspect of an embodiment of a system according to the present invention, a sound pickup (e.g., dual coil or humbucker) is positioned within a sound hole of a stringed instrument (e.g., a guitar), the stringed instrument having a soundboard. A volume control and a first output jack may be supported by the stringed instrument. The output of the pickup is electrically coupled to an input terminal of the volume control and an output terminal of the volume control is electrically coupled to the output jack.

According to another aspect of an embodiment of a system according to the present invention, the stringed instrument further includes a second output jack. The second output jack is preferably electrically coupled to a second pickup, such as a

According to still another aspect of an embodiment of a system according to the present invention, such system includes an adaptor frictionally engaged with at least a portion of an edge of the sound hole, and the humbucker is securely coupled to the adaptor, such as by mechanical fasteners (e.g., screws) or adhesive. The adaptor and/or pickup (individually or collectively) preferably occupies a majority of the sound hole but less than the entirety of the sound hole.

According to a further aspect of an embodiment of a system according to the present invention, the volume control may be supported by the soundboard.

According to an aspect of an embodiment of a method according to the present invention, such method includes step of positioning a humbucker in a sound hole of a stringed instrument, the stringed instrument having a soundboard.

According to another aspect of an embodiment of a method according to the present invention, such method may further include the step of securing the humbucker in the sound hole through (i.e., by way of or using) an adaptor, at least one of the adaptor and the humbucker occupying a majority of the sound hole, but preferably less than the entirety of the sound hole.

According to still another aspect of an embodiment of a method according to the present invention, such method may further include the step of transducing electrical signals received directly or indirectly from the humbucker to produce a first sound perceptible to a human ear (e.g., by amplification or other processing and/or use of a speaker).

According to still another aspect of an embodiment of a method according to the present invention, such method may further include the step of acoustically transmitting a second sound unobstructed through a portion of the sound hole, the second sound being perceptible to the human ear.

According to an aspect of an embodiment of a kit according to the present invention, such kit includes (in one or more related packages) a sound transducer (preferably a dual coil or humbucker), a sound hole adaptor, and an output jack. The adaptor is preferably configured to receive and support the sound transducer and configured to be inserted into a sound hole of a stringed instrument. The output jack is preferably configured to be electrically coupled to the sound transducer. A volume control may also be included in the kit, the volume control being configured to be electrically coupled between the sound transducer and the output jack.

According to another aspect of an embodiment of a kit according to the present invention, such kit may include some preconnected components in the package. For instance, the output jack may be electrically coupled to the sound transducer. Additionally or alternatively, the volume control may be electrically coupled to the sound transducer. Additionally or alternatively, the volume control may be electrically coupled to the output jack.

According to still another aspect of an embodiment of a kit according to the present invention, such kit may include an electrical cable configured to mate with the output jack.

### BRIEF DESCRIPTION OF THE DRAWINGS

FIG. 1 is a front perspective view of an embodiment of a sound system according to the present invention incorporated into a guitar.

FIG. 2 is a front elevation view taken along line 2 of FIG. 1.

FIG. 3 is a partial left side elevation view of the embodiment of FIG. 1.

FIG. 4 is a front elevation view of an embodiment of a pickup module of the sound system of FIG. 1.

FIG. 5 is perspective view of an embodiment of a sound hole adaptor according to the present invention.

FIG. 6 is a front elevation view of the embodiment of FIG. 5.

FIG. 7 is a cross-sectional view taken along line 7-7 of FIG. 6.

FIG. 8 is a schematic representation of an embodiment of a sound system according to the present invention.

FIG. 9 is a schematic representation of a second embodiment of a sound system according to the present invention

FIG. 10 is a cross-sectional view taken along line 10-10 of FIG. 2.

### DESCRIPTION OF THE PREFERRED EMBODIMENT

Although the disclosure hereof enables those skilled in the art to practice the invention, the embodiments described merely exemplify the invention which may be embodied in other ways. While the preferred embodiment has been described, the details may be changed without departing form the invention, which is defined by the claims.

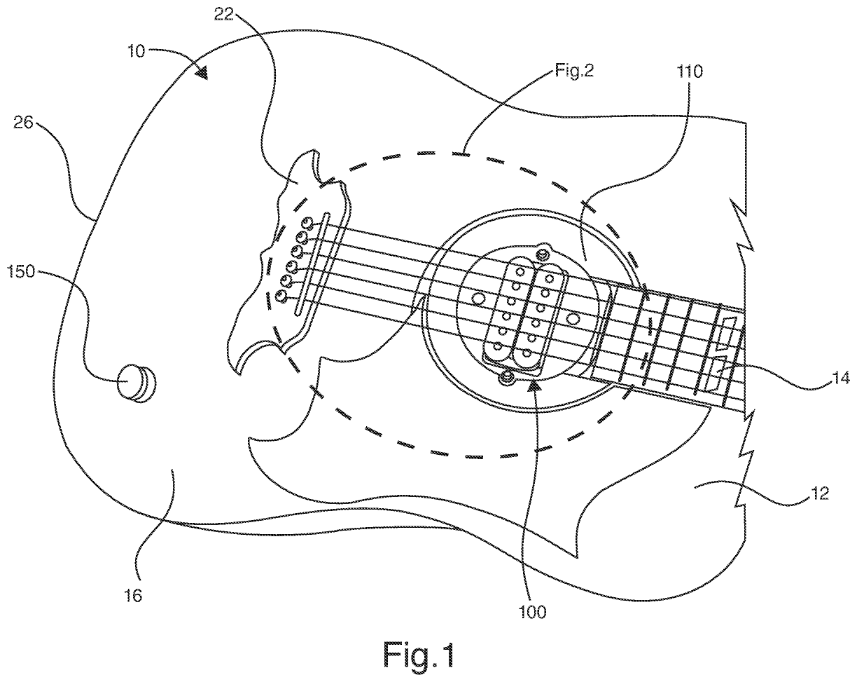

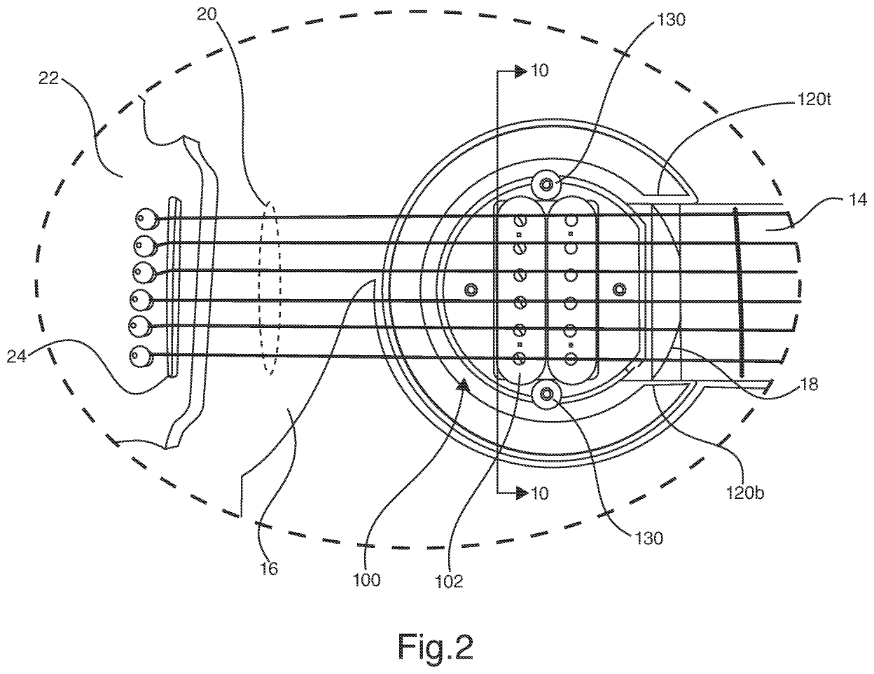

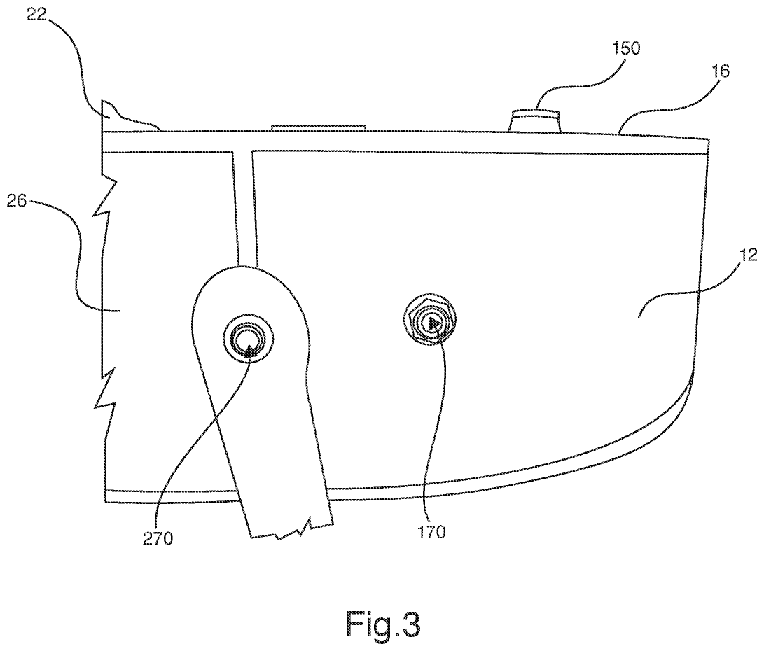

Turning now to the figures, FIGS. 1-3 show an embodiment of a sound system 100 incorporated into or otherwise supported by a guitar 10 that has some acoustic (i.e., non-electric) sound producing or passive amplification capability. As is conventional, the guitar 10 has a hollow guitar body 12 and a neck 14 (only partially shown fretboard) extending therefrom. The body 12 has a front panel, generally referred to as a soundboard 16, through which a sound hole 18 extends. The sound hole 18 is conventionally at least substantially circular, though the invention should not be limited thereto. The guitar 10 has a plurality of suspended strings (20E,20A,20D,20G,20B,20e, or collectively or individually 20), extending from a distal end of the neck 14 (e.g., each string 20 coupled to a tensioning or tuning key), across a nut 14a, to a bridge 22 over a saddle 24, the saddle 24 positioned between the sound hole 18 and a tail end 26 of the body 12.

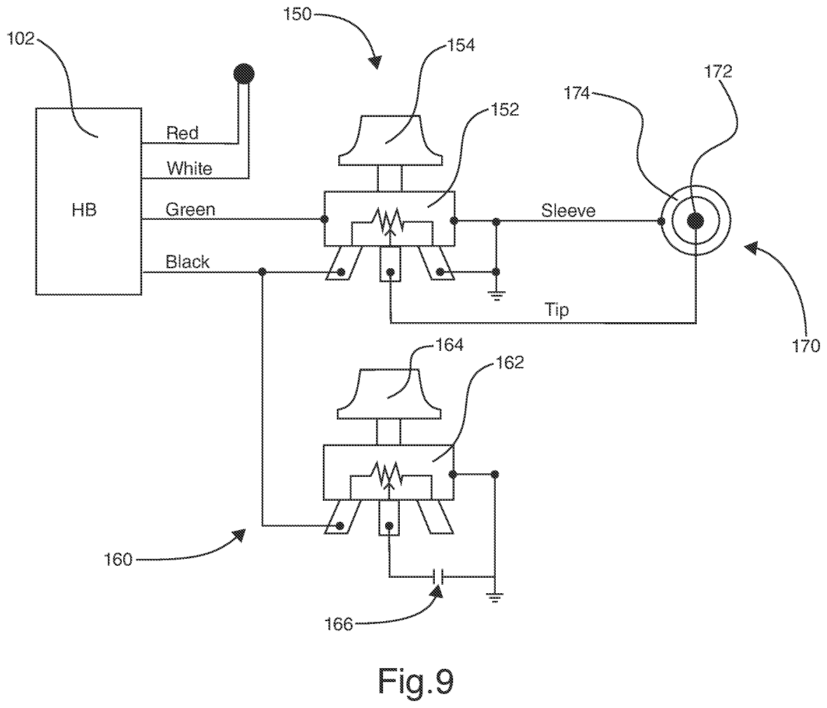

In the embodiment 100 shown, the sound system includes a pickup 102 supported by a sound hole adaptor 110, the pickup 102 being electrically coupled to a volume control 150 and an output jack 170, and may additionally be coupled to a tone adjustment control 160 (described in connection with FIG. 9).

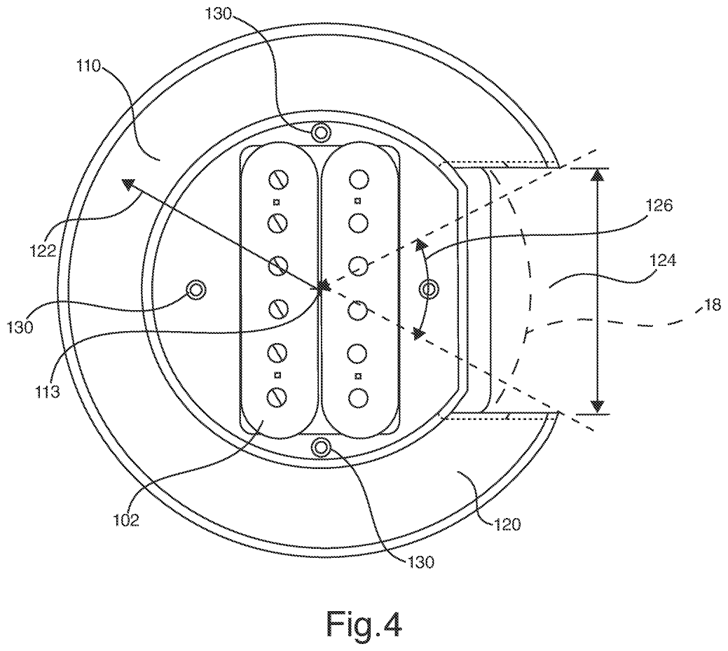

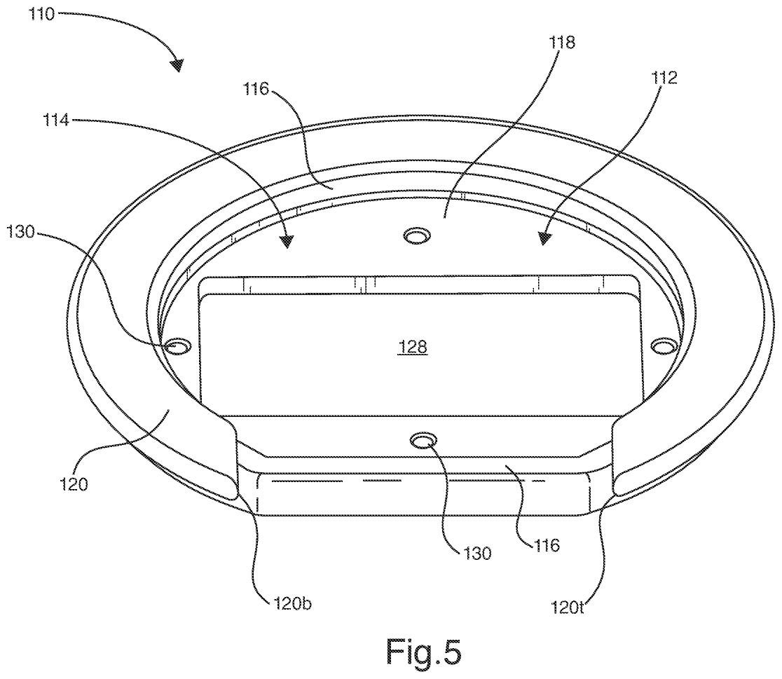

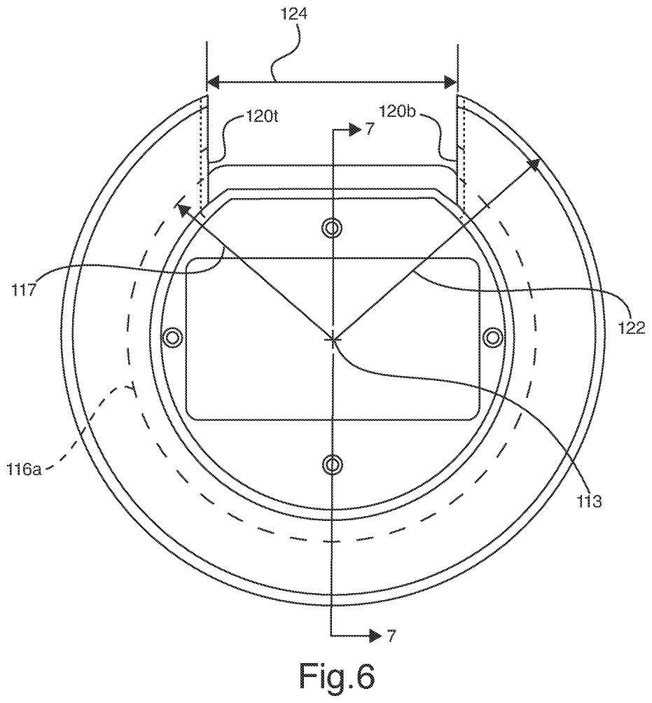

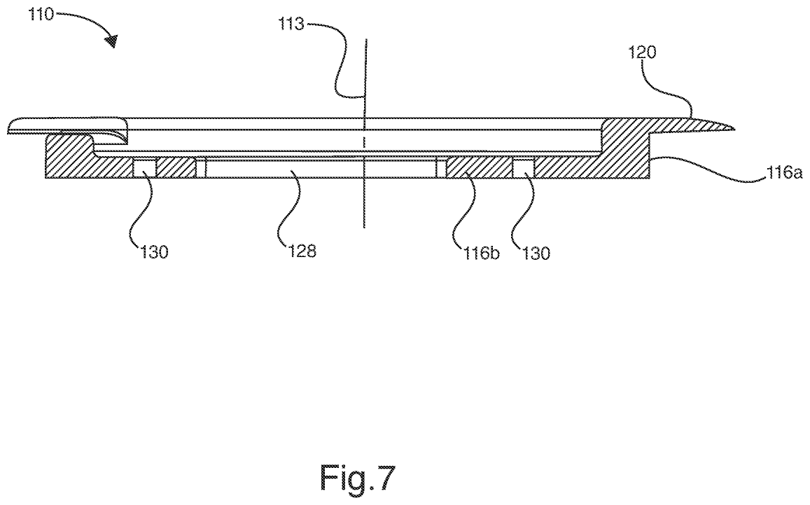

While the pickup 102 may take a variety of forms, a preferred pickup 102 is a humbucker, or double coil pickup, such as a Seymour Duncan model SH-4 JB. The pickup 102 is physically secured to the sound hole adaptor 110 and supported thereby. Turning more particularly to FIGS. 4-7, the sound hole adaptor 110 may be described in greater detail. The adaptor 110 generally includes a cup portion 112 formed about an adaptor axis 113, the cup portion 112 having an open top 114 surrounded by a substantially cylindrical wall 116 and a bottom 118. The wall 116 has an outer surface 116a, which is preferably disposed along a substantially uniform sound hole radius 117 from the adaptor axis 113. The sound hole radius 117 is selected and/or predetermined so as to cooperate with (e.g., at least partially frictionally engage) an edge of the soundboard 16 surrounding the sound hole 18 of the guitar 10. Alternatively, the sound hole radius 117 of the adaptor 110 may be less than a radius of the sound hole 18 in the guitar 10. In such case one or more gaskets may be used to situate the adaptor 110 in the sound hole 18.

The adaptor 110 further includes a registration flange 120 extending radially outwardly from the wall 116. The registration flange 120 is generally disc-shaped, and it preferably extends around less than 360 degrees of the adaptor axis 113. In a preferred embodiment, the flange 120 is substantially C-shaped, extending from a top flange terminus 120t, about the adaptor axis 113 at a flange radius 122, to a bottom flange terminus 120b. In preferred embodiments, the flange termini 120t, 120b contact the guitar neck 14, preventing the adaptor 110 from twisting or rotating within the sound hole 18 during use and/or storage. This twist prevention is preferred to maintain the pickup 102 in a preferred orientation relative to the strings 20.

The flange termini 120t,120b also define a flange gap 124. The flange gap 124 preferably provides a space that is at least as wide as a collective spacing of all of the strings 20 on the guitar 10. Within the flange gap 124, the cylindrical nature (or otherwise sound hole 18 mating structure) of the wall 116 is also truncated. Thus, an irregularity in the wall 116 and/or flange 120 preferably eliminates a complete blockage of the sound hole 18 of the guitar 10. Accordingly, conventional acoustic amplification is allowed to occur, and sound waves are allowed to exit through at least a portion of the sound hole 18 without obstruction. As measured between the flange termini 120t,120b and with respect to the adaptor axis 113, blockage of the sound hole 18 may be prevented through a gap angle 126. A preferred gap angle 126 is between about 20° and about 100°, with between about 45° and about 75° being more preferred, and between about 60° and about 65° being most preferred. The flange gap 124 preferably provides an open portion of the sound hole 18 (when inserted therein) having an area (measured coplanar with the soundboard 16) of about 0.40 square inches to about 0.60 square inches with about 0.45 square inches (+/−about 0.025 square inches) preferred. Alternate embodiments may feature an adaptor 110 that completely blocks the sound hole 18 if the acoustic properties of the guitar are not desired.

The bottom 118 of the cup portion 112 of the adaptor 110 may be imperforate or it may include one or more apertures to cooperate with the pickup 102, or other supportive structure. According to the depicted preferred embodiment, the bottom 118 includes a pickup aperture 128 formed therethrough. The pickup aperture 128 is configured to receive at least a portion of the pickup 102, preferably having been inserted from a rearward direction 116b. One or more mounting and/or vent apertures 130 may be provided extending through the adaptor 110, such as through the bottom 118.

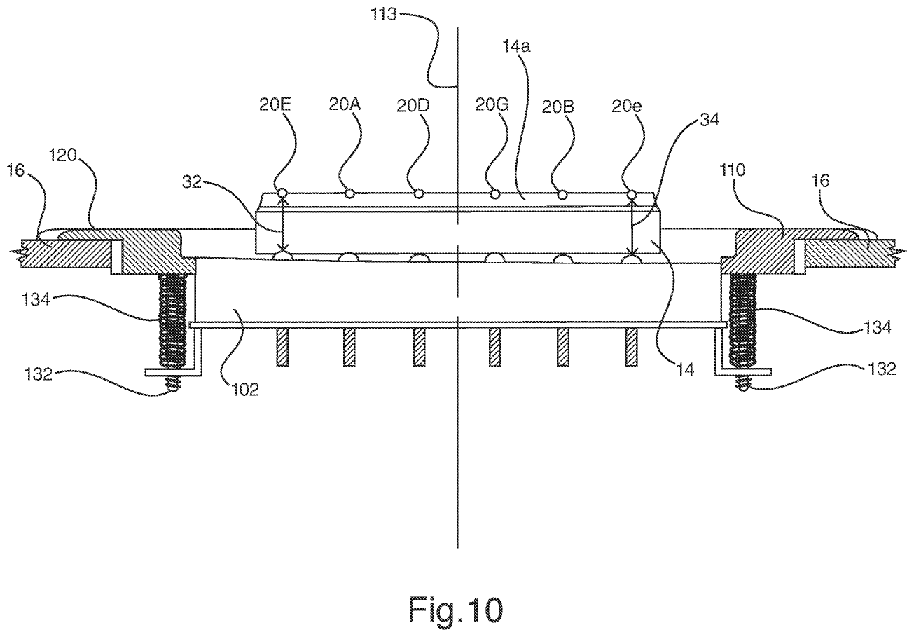

The coupling of the pickup 102 to the sound hole adaptor 110 may be achieved in a number of ways, including adhesive (e.g., if the bottom 118 is imperforate). However, a preferable mounting of the pickup 102 to the adaptor 110 includes extending at least a portion of the pickup 102 through the pickup aperture 128 and securing the pickup 102 to the adaptor 110 with one or more threaded fasteners, such as machine screws (e.g., screws 132 extending through apertures 130, as seen in FIG. 10).

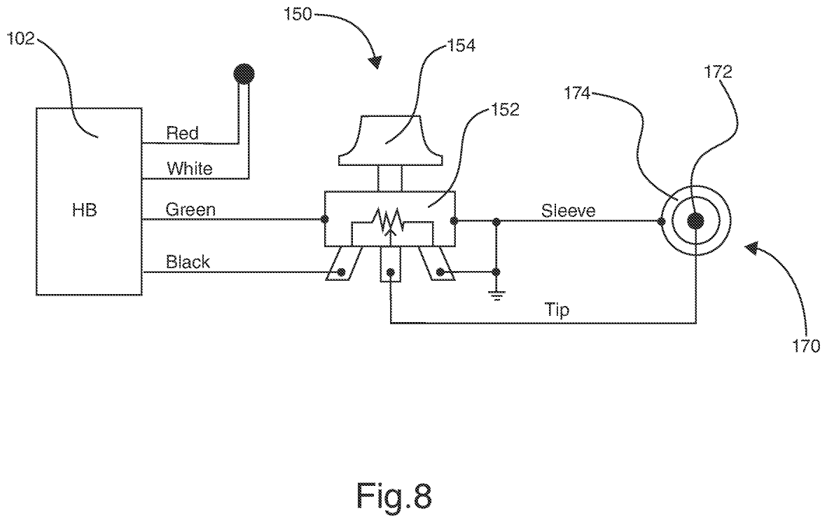

FIG. 8 provides a first schematic representation of a sound system 100 according to the present invention, without the use of a tone adjustment (further described below). Generally, the pickup 102 provides an active (e.g., variable) electrical signal (black) which is electrically coupled to a first terminal on a potentiometer 152 of the volume control 150. The pickup 102 also provides a passive return (e.g., ground) electrical connection (green) which may be electrically connected to ground, such as through a metal case of the potentiometer. A second terminal of the potentiometer 152 is grounded, too, as is a sleeve contact 174 of the output jack 170. A potentiometer wiper terminal is electrically connected to a tip contact 172 of the output jack 170. The wiper position (i.e., the operation of the voltage divider defined by the potentiometer) is controlled by a rotatable knob 154. A preferred volume potentiometer 152 is a CTS 500 kΩ split-shaft audio pot.

FIG. 9 provides a second schematic representation of a sound system 100 according to the present invention, including the components of the first schematic from FIG. 8, further including a tone adjustment control 160. Generally, the pickup 102 provides an active (e.g., variable) electrical signal (black) which is electrically coupled to a first terminal on a potentiometer 162 of the tone adjustment control 160. A potentiometer wiper terminal is electrically connected to ground (and hence to the sleeve 174) through a filtering capacitor 166, such as a 0.047 μF nonpolarized capacitor. The wiper position of the tone adjustment control 160 is controlled by a rotatable knob 164. A preferred tone adjustment potentiometer 162 is a no-load CTS 500 kΩ split-shaft audio pot.

To use the sound system 100 according to the present invention, in its most basic form, the pickup 102 is mounted at least partially within a sound hole 18 of a guitar 10, and electrical signals from the pickup 102 (with or without modification in or at the guitar 10) are conveyed (through the output jack 170) away from the guitar 10 for amplification, mixing, and/or other processing. In a preferred arrangement, the pickup 102 is secured to the adaptor 110, and the adapter 110 is frictionally positioned within the sound hole 18 (with or without one or more gaskets) of the guitar 10, while the electrical connections are hidden within the body 12. A gasket, while not necessary, may simplify manufacturing of the system 100, as the gasket would allow an adaptor 110 of a single size to fit most guitars. A hole or slot may be carefully formed (e.g., by drilling) in the soundboard 16 to receive and support the volume control 150, and another hole may be carefully formed (e.g., in the tail end 26 of the body 12) to receive and support the output jack 170. If a tone adjustment control 160 is also used, another hole or slot may be carefully formed (e.g., by drilling) in the soundboard 16 to receive and support it. In this way, an electrical connection can be created between the output jack 170 and additional audio processing equipment by way of a conventional cable (e.g., a ¼ inch audio cable). The additional audio processing equipment may include, for example, one or more of a pedal, an amplifier, and a mixer. The audio processing may include one or more of amplification, filtering, compression, time-shifting, tremolo, gain, modulation, pitch change, autotuning, etc.

In addition to the amplification, mixing, and/or other processing of signals from the pickup 102, the system 100 advantageously allows for at least partial use of the traditional acoustic amplification provided by the guitar 10. That is, the flange gap 124 and/or truncation of the wall 116 prevents complete coverage of the sound hole 18. Accordingly, not only is an electrically processed sound presented to a listener in the proximity of the guitar 10, but an acoustic sound is also provided. In this manner, by allowing some acoustic sound waves to travel, unobstructed, through a portion of the sound hole 18, advantageous sound qualities may be realized. Alternatively, the adaptor 110 could cover the entirety of the sound hole 18 (except for one or more minimal vent holes 130) if the device 100 is to be used in an environment with substantial amplification (e.g., on stage with or without monitors) to minimize feedback.

Additionally, the guitar 10 may be provided with or without a second output jack 270, which may be a direct or indirect output from one or more transducers otherwise positioned to capture sound produced by the guitar and convert or transduce such sound into electrical signals provided at the second output jack 270, which can then be conveyed for amplification, mixing, and/or other processing. For example, the second output jack 270 may receive electrical representations of soundwaves from a microphone positioned within the body 12 of the guitar 10 or a piezoelectric transducer positioned against the soundboard 16, opposite the saddle 24. In this way, a plurality of electrically transduced soundwave representations may be provided at a plurality of output jacks 170,270 to be conveyed for amplification, mixing, and/or other processing.

The electrical connections between components (e.g., pickup 102, volume control 150 and/or tone adjustment 160, and jack 170) are made using electrical wire that is soldered or otherwise electrically connected to the various components. A preferred electrical wire is insulated, 22 gauge (22 AWG) multi-strand wire.

Turning now to FIG. 10, a cross-sectional view of the system 100 can be seen. Preferably, the pickup 102 may be paired with or secured to the adaptor 110 through the use of one or more fasteners, such as screws 132. Further, a biasing spring 134 may be optionally wound around the screw 132 and disposed between the adaptor 110 and a portion of the pickup 102, allowing for adjustment of the pickup 102 relative to the strings 20. Thus, a first portion of the pickup 102 is located at a first distance 32 from one 20E of the strings and a second portion of the pickup 102 is located at a second distance 34 from another 20e of the strings, where the distances 32,34 can be substantially the same, or can be adjusted to achieve different tone profiles. Instead, the pickup 102 may feature a surface that is sloped, as seen in FIG. 10. This feature results in a varying distance between the strings 20 and the pickup 102. The minimum distance 32 between the strings 20 and pickup 102 is less than the maximum distance 34. This arrangement allows for variations in tone. Additionally or alternatively, tone variations may be provided by a pickup 102 secured to an adaptor 110 with a predetermined slope, wherein various adaptors 110 may be exchanged (i.e., removed from and inserted into the sound hole 18) to achieve different tone profiles.

A kit according to the present invention may be assembled to include a one or more system components in the same or related packaging (e.g., bag(s), box(es), clamshell(s), etc.). Generally, such kit includes at least the sound hole adaptor 110, and preferably includes the pickup 102 and the output jack 170. A kit may optionally include the volume control 150, tone adjustment control 160, and/or one or more gaskets. Two or more of the system components may be provided in the kit packaging as having been electrically preconnected, such as by wires being soldered or otherwise connected for operation. Alternatively, the components may be provided unconnected (with or without disconnected electrical wires) to allow an end user to assemble the kit into a guitar. Additionally or alternatively, electrical connections may be nondestructively connectable and disconnectable, such as through the use of mating connectors (e.g., plugs/jacks) to allow a more temporary use of the system.

While the above discussion is offered with respect to a sound system 100 for use in connection with a conventional guitar 10 having a substantially circular sound hole 18, the present invention may also be used in connection with other stringed instruments. Indeed, the present invention is advantageous in that at least one embodiment provides a means of conveying both electrical representations (i.e., transduced or converted) of sounds and acoustically amplified sound waves, rather than requiring a user of a guitar to rely on only a sole sound type.

The foregoing is considered as illustrative only of the principles of the invention. Furthermore, because numerous modifications and changes will readily occur to those skilled in the art, it is not desired to limit the invention to the exact construction and operation shown and described. For instance, although the preferred embodiment depicts the flange gap 124 disposed between the pickup 102 and the guitar neck 14, it is further contemplated that the gap 124 may alternatively or additionally be disposed between the pickup 124 and the bridge 22. While the preferred embodiment has been described, the details may be changed without departing from the invention, which is defined by the claims.

What is claimed is:

1. A system comprising:
a humbucker positioned within a sound hole of a stringed instrument, the stringed instrument having a soundboard;
a volume control supported by the stringed instrument; and
a first output jack supported by the stringed instrument,
wherein an output of the humbucker is electrically coupled to an input terminal of the volume control and an output terminal of the volume control is electrically coupled to the output jack.

2. The system according to claim 1, wherein the stringed instrument is a guitar.

3. The system according to claim 2, wherein the guitar further includes a second output jack.

4. The system according to claim 3, wherein the second output jack is electrically coupled to a piezoelectric pickup.

5. The system according to claim 1, further comprising an adaptor frictionally engaged with at least a portion of an edge of the sound hole, the humbucker being securely coupled to the adaptor.

6. The system according to claim 5, wherein at least one of the adaptor and the humbucker occupies a majority of the sound hole, and further wherein the at least one of the adaptor and the humbucker occupies less than the entirety of the sound hole.

7. The system according to claim 1, wherein the volume control is supported by the soundboard.

8. A method comprising the step of:
positioning a humbucker in a sound hole of a stringed instrument, the stringed instrument having a soundboard.

9. The method according to claim 8, further comprising the step of securing the humbucker in the sound hole through an adaptor, at least one of the adaptor and the humbucker occupying a majority of the sound hole.

10. The method according to claim 9, wherein the at least one of the adaptor and the humbucker occupies less than the complete sound hole.

11. The method according to claim 10, further comprising the step of transducing electrical signals received directly or indirectly from the humbucker to produce a first sound perceptible to a human ear.

12. The method according to claim 11, further comprising the step of acoustically transmitting a second sound unobstructed through a portion of the sound hole, the second sound being perceptible to the human ear.

13. A kit comprising:
a sound transducer;
an adaptor, the adaptor being configured to receive and support the sound transducer and being configured to be inserted into a sound hole of a stringed instrument;
an output jack configured to be electrically coupled to the sound transducer.

14. The kit according to claim 13, the kit further comprising:
a volume control configured to be electrically coupled between the sound transducer and the output jack.

15. The kit according to claim 14, wherein at least one of (a) the output jack is electrically coupled to the sound transducer, (b) the volume control is electrically coupled to the sound transducer, and (c) the volume control is electrically coupled to the output jack.

16. The kit according to claim 13, wherein the sound transducer comprises a humbucker.

17. The kit according to claim 13, wherein the output jack is electrically coupled to the sound transducer.

18. The kit according to claim 13, further comprising an electrical cable configured to mate with the output jack.
